(19) United States
(12) Patent Application Publication
(10) Pub. No.: US 2018/0281900 A1
(43) Pub. Date: Oct. 4, 2018

(54) FOLDABLE STRUCTURES

(71) Applicant: ONAK BVBA, Gent (Zwijnaarde) (BE)

(72) Inventors: Otto VAN DE STEENE, Gent (BE); Thomas WEYN, Gent (BE); Timothy GALLE, Melle (BE)

(21) Appl. No.: 15/764,530

(22) PCT Filed: Oct. 2, 2016
(86) PCT No.: PCT/IB2016/055895

§ 371 Date: Mar. 29, 2018

(30) Foreign Application Priority Data
Oct. 1, 2015 (BE) BE2015/5605

(51) Int. Cl. B63B 7/06; B63B 35/71; B29C 53/06

(52) U.S. Cl. CPC B63B 7/06; B63B 2007/003; B29C 53/06; B63B 35/71

(57) ABSTRACT

A foldable system is described. The system includes a panel consisting of at least two layers, a first flexible layer and a second non-flexible layer, the first and the second layer being attached to each other such that they form a whole, the panel including folds, the folds being applied in the second layer such that the panel can be folded into a predetermined shape. In addition, the first flexible layer includes material with a higher melting temperature than the melting temperature of the second layer.

### AREA OF APPLICATION OF THE INVENTION

The present invention generally relates to foldable structures. The invention relates to a foldable structure, as well as the material which can be used for such a foldable structure and the technique for producing such a foldable structure.

### BACKGROUND OF THE INVENTION

Foldable structures are useful for objects that by their weight and shape generally are not suitable to be transported in, for example, a car or, for example, to be worn during hikes. Boats are examples of this.

For this purpose, boats are typically developed that can be made compact for during transport and which can be built up with as few additional tools as possible and as fast as possible.

A type of boat which is compact during transport is inflatable boats. A disadvantage of this type of boat is however that inflation may take a long time and that they are also vulnerable to wear or breakage because sharp objects in the navigated water can give rise to leakage of the air compartments.

Another type of boat which can be made compact is illustrated in US2008/0041295. This boat consists of a watertight skin and a plurality of ribs that form the structure around which the skin can be tensioned. Preparing for sailing, however, can take a lot of time.

In U.S. Pat. No. 6,615,762, a boat is described in which the need for a skeleton structure is avoided. The boat is constructed of extruded, corrugated plastic plates, it being possible to fold them into a boat shape. The boat is made watertight by providing a watertight cover that is folded around the plates.

However, there is room for a more efficient system that is foldable, for example, into a boat, and for a more efficient method for making such a system.

### SUMMARY OF THE INVENTION

It is an aim of embodiments of the present invention to provide good foldable systems and materials, such as, for example, systems that can be folded into a boat, as well as good techniques to efficiently produce such foldable systems.

It is an advantage of embodiments of the present invention that efficient production methods are provided to make prototypes and other examples of foldable objects.

It is an advantage of embodiments of the present invention that production methods can be used that can produce different designs in a simple and efficient way without expensive or complex tools being required for the production.

It is an advantage of embodiments of the present invention that production methods can be based on a CNC-based production system

It is an advantage of embodiments of the present invention that foldable systems are not limited to boats or boats, such as, for example, canoes, kayaks, rowing boats, etc., but that they also offer applications in, for example, folding caravans, temporary enclosures, sturdy watertight packaging, roofs for mobile homes, loading compartments of vans, toys for children, etc . . . .

It is an advantage of embodiments of the present invention that a solid and stable construction is obtained. In the case of boats or vessels, these furthermore have a high level of stability on the water, as regards both primary and secondary stability.

It is an advantage of embodiments of the present invention that a watertight construction is obtained that can be made ready for use efficiently. It is an advantage of embodiments of the present invention that separate watertighting no longer needs to be applied.

The above-mentioned aim is achieved by a device, apparatus and/or method according to the present invention.

The present invention relates to a foldable system, the system including a panel consisting of at least two layers, a first flexible layer and a second non-flexible layer, the panel including folds, the folds being applied in the second layer so that the panel can be folded into a previously intended shape. The first and second layer are permanently connected with each other so that they form a panel consisting of one whole. The first flexible layer includes a material with a higher melting temperature than the melting temperature of the second layer. In some embodiments, the first flexible layer has a higher melting temperature than the melting temperature of the second layer.

Due to the higher melting temperature of the first flexible layer, it is possible to melt the second layer by locally heating the first layer, i.e., by directly heating the first layer and only heating the second layer indirectly, without the first layer itself melting. Thus, no direct contact between the heat source and the second layer is required.

In embodiments of the present invention, the first flexible layer and the second layer can already be connected to each other before the application of the folds, for example, via lamination or gluing. It is an advantage of such an embodiment that the first layer holds the second layer in place and keeps it in shape, so that no material runs off during the production process of the folds. This allows the second layer to be warmed up to or above the melting temperature, without it being damaged.

Preferably, the melting temperature of the first flexible layer and the second layer will differ by at least 80° C., for example, by at least 100° C. It is an advantage of some embodiments that the creation of folds can be done by heating locally and making a groove in the locally heated material that forms the folding line. In some embodiments, this can be done by providing one or more hot air blowers on a CNC machine, combined with an element for forming a groove, for example, a blunt rolling blade. The hot air is then applied shortly before the rolling blade passes, so that the second layer is melted and the first layer has been made softer and moister. By applying pressure with the element, a groove is formed, whereby the layer can easily be folded at that place.

Furthermore, in particular embodiments, in addition to fold lines, other forms be created, wherein a selected shape can be pressed in the locally melted portion. This allows other patterns to be generated in the second layer.

The fact that the first layer has a higher melting temperature than the second layer also allows for faster pressing cycles in a press. The higher melting temperature can be used to avoid the material from attaching itself to the press. Consequently, shorter cooling cycles and heating cycles can be used.

In theory, both the first layer as the second layer can consist of multiple layers, such as, for example, glue layers, multiple layers of self-reinforced polypropylene embedded in normal polypropylene, etc. In addition, an equivalent of the second layer or another layer can be provided on both sides of the first layer.

It is an advantage of embodiments of the present invention that a predetermined form or structure, such as, for example, a boat, can be folded out of a panel. It is an advantage of embodiments of the present invention that this can be done rapidly. It is an advantage of embodiments of the present invention that a structure can be folded whose stiffness and strength can be increased by the presence of the second layer in the panel. By increasing the strength, the structure, for example a boat, can for example be better used in a harsh environment, such as, for example, in rivers with a rough riverbed for boats. Due to the stiffness and strength, a boat according to embodiments of the present invention will have similar sailing characteristics as a non-foldable boat of the same shape and size. It is an advantage of embodiments of the present invention that the panel can be made foldable by the presence of the first layer in the panel.

It is an advantage of the present invention that the parts of the structure are easy to produce automatically, without requiring much manual labour.

It is an advantage of the present invention that if it relates to, for example, a boat, the boat will be of a similar strength as a hard, non-folding boat. The boat will have a similar impact and abrasion resistance.

It is an advantage of the present invention that the object, for example, the boat, can be made from a water slippery material, for example, a material that is more water slippery than a rubber or PVC.

It is furthermore an advantage of embodiments of the present invention that a flexible layer is provided on the rigid layer. By making a cut in the second layer, it is possible to fold, with the first layer as hinge point. In addition, no incision is made in the first flexible layer, and when this is watertight, the final folded object will also be watertight.

The desired form can take the shape of a boat.

The boat can be a canoe or a kayak.

The cross section of the folding line can be an angle. It is an advantage of embodiments of the present invention that the degree of foldability of the panel around the fold can be adjusted by adjusting the size of the angle. By, for example, making a folding line with an angle of 90°, the panel around the folding line can be folded such that the plane along the one side of the folding line forms an angle of 90° with the plane along the other side of the folding line.

Two fold lines can be located adjacent to each other and the distance between the two fold lines can be smaller than the width of a folding line. It is an advantage of embodiments of the present invention that the foldability of the panel around the two fold lines is greater than if there were only one folding line. By, for example, placing two fold lines, each with an angle of 90°, next to each other, the panel around these fold lines can be folded such that the plane along the one side of the folding line comes up against the plane along the other side of the fold. These folds are also referred to as ‘double fold lines’.

By combining multiple fold lines, each with a sharper angle, for example, each with an angle of 30°, it is possible to approximate an arc.

The second layer can contain material with a cell structure. This cell structure can also be a honeycomb structure. It is an advantage of embodiments of the present invention that a material with a honeycomb structure provides firmness in several very distinct directions and not only substantially in one direction.

It is an advantage of embodiments of the present invention that the cell structure is a rigid structure which gives rigidity to the panel, and ultimately to the formed object when the panel is folded. It is an advantage of embodiments of the present invention that the panel is made of a material which is lighter than water and thus is unsinkable. It is an advantage of embodiments of the present invention that the material of the panel can withstand temperatures of up to −20° C. or even up to −50° C. For example, a material can be used consisting of polypropylene, to which polypropylene carbonate has been added. Also, the flexible material can be chosen such that it is resistant to very cold temperatures, such as, for example Curv.

The present invention also relates to a method for the application of folds in a panel, the panel consisting of a first layer and a second layer, the folds only being applied in the second layer by means of pushing in/pressing a groove or locally melting away material or locally pushing away material. The technique furthermore involves locally heating the structure, from the side of the first layer. More specifically, the second layer is indirectly melted locally by locally heating, at the location where the fold is to be applied, the first layer, below the melting temperature of the first layer, but above the melting temperature of the second layer, and by spontaneous conduction of the applied heat to the second layer.

The groove can be provided with a CNC-controlled machine.

The local heating can be done by means of a thermal source mounted on the CNC-controlled machine.

The local heating can take place at a temperature that is between 15% and 50% of the temperature difference between the melting temperature of the first layer and the second layer lower than the melting temperature of the first layer, preferably between 20% and 40% of the temperature difference between the melting temperature of the first layer and the second layer lower than the melting temperature of the first layer.

It is an advantage of embodiments of the present invention that the material changes made for the folds are located mainly or solely in the second layer. Although in essence the fold is formed by forming it in the second layer, it will be apparent to a person skilled in the art that deformations can also occur in the first layer. It is an advantage of embodiments of the present invention that the depth and the position of the folds can be controlled. It is an advantage of embodiments of the present invention that the angle of the fold can be determined, for example, by the way in which the groove is applied.

It is an advantage of embodiments of the present invention that a tear in the second layer, for example, at the height of a fold, will not continue in the first layer.

Particular and preferred aspects of the invention are set out in the appended independent and dependent claims. Features of the dependent claims may be combined with features of the independent claims and with features of other dependent claims as appropriate and not merely as explicitly set out in the claims.

The above and other aspects of the invention will be apparent from and elucidated with reference to the embodiment(s) described hereinafter.

### BRIEF DESCRIPTION OF THE DRAWINGS

FIG. 1 shows the cross-section of a panel, including a fold line with an angle of 90°, according to embodiments of the present invention.

FIG. 2 shows the cross-section of a panel, including two fold lines, each with an angle of 90°, according to embodiments of the present invention.

FIG. 3 shows the cross-section of a panel, including a fold line with an angle of 0°, according to embodiments of the present invention.

FIG. 4 shows a 3D-drawing of a folded panel, according to embodiments of the present invention.

FIG. 5 shows the top view of a panel according to embodiments of the present invention.

FIG. 6 shows the top view of a boat according to an embodiment of the present invention.

The drawings are only schematic and are non-limiting. In the drawings, the size of some of the elements may be exaggerated and not drawn on scale for illustrative purposes.

Any reference signs in the claims shall not be construed as limiting the scope. In the different drawings, the same reference signs refer to the same or analogous elements.

### DETAILED DESCRIPTION OF ILLUSTRATIVE EMBODIMENTS

Although the present invention will hereinafter be described with respect to particular embodiments and with reference to certain drawings, the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms ‘first’, ‘second’ and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, above, front and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term ‘includes’, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression ‘a device including means A and B’ should not be limited to devices consisting only of components A and B. It means that with respect to the present invention, the only relevant components of the device are A and B.

Reference throughout this specification to ‘one embodiment’ or ‘an embodiment’ means that a particular feature, structure or characteristic described in connection with the embodiment is included in at least one embodiment of the present invention. Thus, the appearance of the phrases ‘in one embodiment’ or ‘in an embodiment’ in various places throughout this specification do not necessarily all refer to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the description of illustrative embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

Where in embodiments of the present invention reference is made to the ‘folding corners’, the angles in the panel are meant which are formed when the panel is fully unfolded to form the intended system, for example, a boat form, or compact form. These are the angles along the folds.

Where in embodiments of the present invention reference is made to the ‘width of a fold line’, the distance will be measured between the two extreme points of the diagonals of the cross-section of the fold line.

Where in embodiments of the present invention reference is made to the ‘distance between two fold lines’, this distance will be measured between the extreme points of the diagonals of the cross sections of the fold lines, the diagonal of the one fold line and the diagonal of the other fold line being chosen such that it will be these diagonals that are closest together.

When in embodiments of the present invention reference is made to a ‘fold’, it may therefore be built up of a single or a double fold line (or possibly even further fold lines).

In a first aspect, the present invention provides a foldable system, for example, a system that can be folded into a vessel. Alternative systems may be, for example, parts of a folding caravan, temporary enclosures, sturdy watertight packaging, roofs for mobile homes, loading compartments of vans, toys for children, etc. By way of illustration, the aspect will be mainly illustrated with reference to a vessel. The vessel may be, for example, a kayak or a canoe. The system includes a panel, the panel being made up of at least a first layer and a second layer. The first layer is a flexible layer and can, for example, be made of PVC and/or polyester. The first flexible layer can, for example, be a coated cloth. In a specific example, the first flexible layer is, for example, made of the material commercially known by the name Curv′. The first layer can be a watertight layer.

The first layer may comprise at least one of the following materials: PET, polyester, COC (cyclic olefin copolymer), polyamide, polystyrene, polycarbonate, PVC or a mixture thereof. However, embodiments are not limited thereto.

In embodiments of the present invention, there is typically at least one non-flexible layer and a flexible layer. The one layer is typically also more rigid than the other layer.

According to embodiments of the present invention, the first flexible layer includes a material with a higher melting temperature than the melting temperature of the second layer. The first layer may also be made entirely from a material having a melting temperature higher than the first layer. In some embodiments, the melting temperature of the first layer can be at least 80° C., for example, at least 100° C., higher than the melting temperature of the second layer.

The second layer may comprise at least polypropylene or consist entirely of this material.

It is to be understood that the first layer and the second layer can each consist of multiple layers.

According to embodiments of the present invention, the first and second layer can be advantageously adhered to each other prior to the application of the folds. The first layer can be applied to the second layer, for example, via lamination. This can be, for example, hot or cold lamination. In some examples, the two layers are, for example, melted together under elevated pressure and elevated temperature (hot lamination). Optionally, additional use can be made of an intermediate layer of adhesive in this process. The first layer can also be glued on the second layer or the second layer can be applied on the first layer using 3D printing techniques. Panels according to the present invention also include folds which are positioned in such a way that the panel can be folded into a particular pattern, for example, into a boat. The size of the system, for example, the boat, can be, for example, between 2 and 6 m. In the case of a boat, it may, for example, have a length of about 5 m (typically a large boat), or it may, for example, have a length of about 3 m (typically a small boat). It is an advantage of embodiments of the present invention that the weight of the object can be limited.

In embodiments of the present invention, folds are provided which allow folding the panel up into a more compact form than when the panel is fully unfolded into the desired form of the system, for example, in boat form. Such a more compact form can, for example, be a beam-shaped double spiral with cavities. By applying a cover plate or tarpaulin to the hollow sides of this more compact form the whole can be transformed into a box and the sides of the plate can be protected.

In some embodiments, the panel comprises a plurality of folds in the transverse direction of the object so that the panel can be folded up into a transport form for transporting the foldable object, the length of the transport form corresponding to the width of the unfolded panel.

In embodiments of the present invention, the second layer has a thickness of between 0.3 mm and 2.0 mm, preferably between 0.6 mm and 0.8 mm. The advantage of a thicker second layer is that a greater rigidity can be obtained. Preferably, an optimum is chosen between a layer with high rigidity and a layer with good pliability and sufficiently low weight. Because the panel according to the present invention typically consists of two layers, a combination of good rigidity, pliability and water resistance is in any case obtained.

The second layer may have a honeycomb pattern. The cells herein are each individually sealed cells. If a hole is made in the panel, the other cells remain intact and still contain air so that the buoyancy of the cells that are not impacted by the hole is not diminished.

Because of the thickness of the second layer, and the fact that the second layer is made of a rigid material (for example, with a honeycomb pattern), the second layer is not foldable. Moreover, a honeycomb pattern is equally rigid in all directions; in other words, it doesn't fold easier in one direction relative to another direction. If the structure is a boat, this results, for example, in a high stability in the water, in both the transverse and longitudinal direction. In order to make the panel foldable, the panel is made of a second layer having thereon a first layer that is foldable. On the folds, material of the second folding layer is removed or it is arranged during production that less material is present there—either over a part of the thickness of the second layer, or completely—so that space is released to fold the panel around the folds and such that, due to the reduced thickness of the second plate, it becomes foldable. By removing the material, the stress, which would be built up in the second plate when folding it, is reduced or even completely removed. The flexible first layer serves as a hinge point. No notches need to be made herein in order to allow the folding so that the panel 110 will remain watertight, if the first layer is watertight.

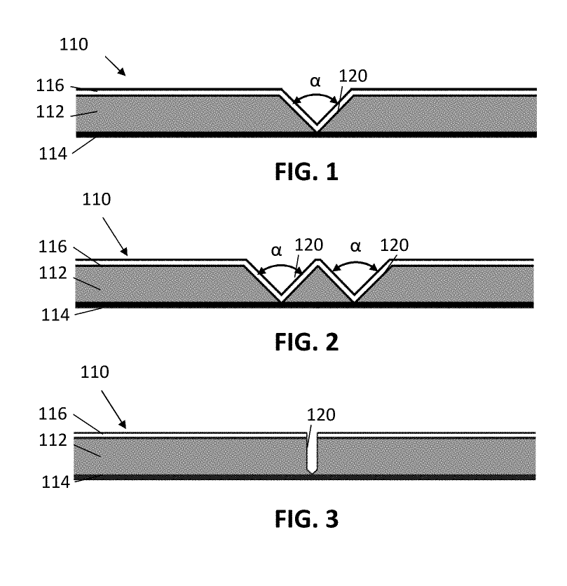

In some embodiments of the present invention, a fold is made by removing a wedge shape from the second layer, or by applying a corresponding groove. The angle of the wedge can be located, for example, between 20° and 130°, for example, between 40° and 110°, for example, between 80° and 100°, for example 90°. An example of this can be seen in FIG. 1. FIG. 1 shows the cross section of a panel 110 according to an embodiment of the present invention. The panel consists of a first flexible watertight layer 114 and a second stiffer layer 112, which is shielded by a third layer 116. In this example, the first layer 114 is a 0.8 mm thick, dark grey PVC-coated polyester layer. In the example, the second layer 112 is a 7 mm thick layer with a honeycomb pattern. A third layer 116 of flexible PVC material is applied to this. This can be done, for example, by means of lamination. In some embodiments, a PVC-coated polyester layer is attached on a polyester non-woven micro fleece layer.

A fold 120 is applied in the second layer 112, and in this example, through the third layer 116. This fold 120 has an angle α of 90°. As a result, the panel can be folded such that the plane along the one side of the fold forms an angle of 90° with the plane along the other side of the fold. In embodiments of the present invention, a fold in this direction is also referred to as an ‘inner fold’. In this case, after folding, the first layer 114 is on the outside of the angle. The angle that can be formed in this case by the folded panel is at an angle of 90°.

FIG. 2 shows an embodiment of the present invention in which two fold lines are arranged next to one another in panel 110. In this embodiment, both fold lines 120 touch each other. Both fold lines 120 have an angle α of 90°. When folding is done according to these fold lines, an inner fold will be formed again. As a result, the one side of the panel can be folded parallel with the second side of the panel. In other words, an inner fold of 180° is formed. In such a situation the fold is such that the outside of the folded panel 110 is formed by the first layer 114.

In some embodiments of the present invention, the fold is made by making an incision in the second layer or cutting through it completely, as a result of which there will be no angle present in the incision. This incision with an angle α of 0°, in other words, does not allow an inner fold to be made, but it does allow an outer fold to be made. With an outer fold, the panel is folded around the fold such that the first layer 114 is located on the inside of the angle. FIG. 3 shows an embodiment of the present invention in which the fold 120 is an incision in the second layer. The panel 110 can be folded such that the one side of the panel 110 is parallel to the second side of the panel 110, and the first layer 114 is located on the inside of the fold.

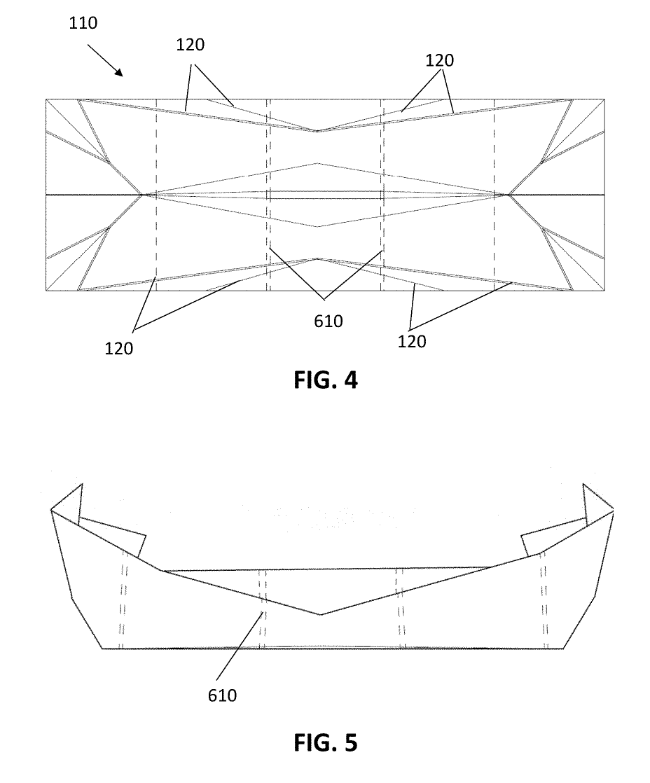

FIG. 4 shows a 3D-drawing of a folded panel 110 according to embodiments of the present invention. The panel is folded according to the folds 120.

FIG. 5 shows a panel 110 according to embodiments of the present invention. The individual continuous lines in the figure are folds through a number of fold lines 120. By folding the panel along these lines, a canoe is obtained. The dotted lines or folds 610 which serve for folding up the boat. In this example, the panel has a size of 365×125 cm. This results in a canoe with a length of about 3 m.

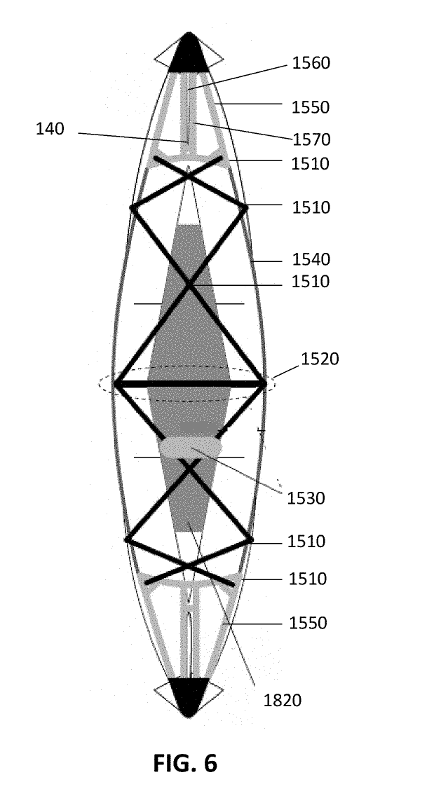

In embodiments of the present invention, the folds 610 for the folding up of the panel 110 are arranged such that the panel can be folded up into a double spiral. Inside the spiral, spaces can thereby be provided in which additional material may be placed. FIG. 6 shows the top view of a specific object, in this case a boat, according to an embodiment of the present invention. Tensioning straps 1540 are applied in the boat which are tensioned from one side to the other side of the folded boat. These tensioning straps 1540 are so arranged in this embodiment of the present invention that they cross each other in the middle of the boat. Over the entire length of the boat, four pairs of tensioning straps 1510 are applied. The tensioning straps 1510 that are closer to the bow or at the stern of the boat are tensioned over a shorter longitudinal distance of the boat than the tensioning straps that are located more towards the centre. Depending on the shape of the vessel, the position of the tensioning straps 1510 and the number of tensioning straps can be different. For example, the tensioning straps may be attached to the vessel by means of ratchet buckles. The tensioning straps can be, for example, polyester tensioning straps with a width of 2.5 mm.

The intersection of two tensioning straps 1510 can be used to support the buttocks when rowing (for example, when rowing in the kneeling position). It is an advantage of embodiments of the present invention that the kneeling position is the most ergonomic way of canoeing. The position of the intersection of the tensioning straps can be changed by means of the ratchet buckles. As a result, even when sailing, the position of the rower can be adjusted slightly (for example, in the vertical direction over a distance of 10 cm) to avoid stiffness. Depending on whether one or two people are sailing, the position of the intersecting straps can be changed. In FIG. 6, at the height of the intersection of the middle tensioning straps 1510, seats 1530 are applied. These seats rest on the tensioning straps 1510 and can be used as support when rowing. These seats 1530 may be made of, for example, EVA (ethylene vinyl acetate).

FIG. 6 also shows a spacer 1520 which is placed between the one side of the vessel and the other side of the vessel. This spacer 1520 can be, for example, an aluminium tube. Other materials such as wood, PVC (polyvinyl chloride) or reinforced polypropylene are also possible. In other embodiments of the present invention, this spacer 1520 can also be, for example, a telescopically extendable walking stick or a photo monopod. In this case, additional accessories can optionally be provided which make it possible to place the walking stick or the monopod on the side walls of the vessel. In embodiments of the present invention, multiple spacers and additional tensioning straps can be applied. Embodiments according to the present invention include a corner plate 1550 which can be placed in the front or back of the vessel. An example of this is shown in FIG. 6. When placed, the corner plate abuts the inner side of the folded boat. In this example, the folded boat has a main fold 1560 both at the front (the bow) and at the rear (the stern). A main fold 1560 can be realised by means of two double folds and one incision whose angle is 0°. Here, a portion of the panel 110 is folded inwardly in order to make the bow and the stern point-shaped. With this main fold 1560, a portion of the panel on the one side of the fold abuts closely with the portion of the panel on the other side of the fold when the panel is folded into boat form. Both sides are then parallel with each other. In embodiments of the present invention, a slot 1570 is provided in the corner plate 1550. This slot 1570 is positioned such that it fits around the main fold 1560 when the corner plate is placed at the front or rear of the vessel. It is furthermore an advantage of embodiments of the present invention that the main fold 1560 is held together by the slot 1570 in the corner plate. A corner plate 1550 may, for example, be secured in the vessel with tensioning straps.

Embodiments of the present invention include slide-over edges 1540 that can be slid over the sides of the vessel (the gunwale). These slide-over edges serve to reinforce the vessel. The above example concerned a canoe by way of illustration of the foldable watertight structures. However, it should be noted that the present invention is not limited thereby. It is to be understood that the panel can also be used for other objects, such as for other boats, or for other structures such as folding caravans, temporary enclosures, sturdy watertight packaging, roofs for mobile homes, loading compartments of vans, toys for children, etc.

In a second aspect, the present invention provides a method for making a fold in the panel. The method is typically applicable to a panel consisting of a first layer and a second layer, the first layer having a higher melting temperature than the second layer, and the folds only being applied in the second layer by means of scoring, locally melting away of material or locally pushing away of material. According to embodiments of the present invention, to this end, the second layer is indirectly melted locally by locally heating, at the location where the fold is to be applied, the first layer, below the melting temperature of the first layer, but above the melting temperature of the second layer, and by conduction of the applied heat to the second layer.

In embodiments of the present invention, the fold is applied through scoring, for example with a blunt blade or wheel. In embodiments of the present invention, the folds can be applied by means of a scoring technique, for example, by means of a CNC (Computerised Numerical Control) scoring technique. The latter method is used, for example, for the application of a fold in a twin-walled polypropylene plate having a honeycomb structure inside. The groove can be formed by pressing down or pressing in of a line or blunt object, such as a blunt wheel. Alternatively, material may also be removed by melting away. In a further alternative, the material may be pressed to the side of the fold line. In advantageous embodiments wherein the non-flexible material consists of a honeycomb structure, no local thickening is caused by this pressing away to the side of the fold line.

The local heating can, for example, be done by means of a thermal source mounted on the CNC-controlled machine. Alternatively, a separate device may be provided for heating.

The local heating can take place at a temperature that is between 5% and 95% of the temperature difference between the melting temperature of the first layer and the second layer lower than the melting temperature of the first layer, for example, between 15% and 50% of the temperature difference between the melting temperature of the first layer and the second layer lower than the melting temperature of the first layer, or preferably between 20% and 40% of the temperature difference between the melting temperature of the first layer and the second layer lower than the melting temperature of the first layer.

The various aspects can easily be combined with each other, and the combinations thus also correspond with embodiments according to the present invention.

By way of illustration, embodiments of the present invention not limited thereby, a specific example will be described of a material and a method for creating folds in such a material.

The material in the present example concerns a layered structure of PET-coated Propex Cury on a polypropylene honeycomb structure having a thickness of 8 mm. The PET layer has a thickness of 0.04 mm. The Propex Cury layer has a thickness of 0.36 mm. It is to be understood that polyester, COC (cyclic olefin copolymer), polyamide, polystyrene, polycarbonate, or a mixture thereof, may be used as an alternative to the PET coating.

An example of a process for creating a fold, as used in the present example, is illustrated below. For the present example, the melting temperature of PET is 260° C., while the melting temperature of polypropylene is only 130° C.

In the process for making a fold, heat is added locally, just before a groove is made with a blunt object. 230° C. was the temperature chosen for the local heating. This is sufficient to weaken the PET and Propex Cury layer, but not to break it when the incision is made, while the inner polypropylene honeycomb structure does melt locally. At that temperature, the PET coating is also sufficiently strong to prevent the Propex Cury material from deforming.

By only adding heat locally the material cools off quickly, as a result of which the created groove retains its shape. If a temperature were to be used that was too high, the cooling would be too slow and the groove would not retain its shape. If a temperature for local heating is chosen which is too low, the honeycomb layer won't melt and the PET layer won't weaken, whereby the outer layer may break. The honeycomb layer will then just return to its original state after the scoring.

It is an advantage of embodiments of the present invention that a CNC technique can be used for making folds in the material, which allows for fast prototyping. In this way the need for hot pressing in order to make folding patterns in the material can be avoided. The applicability of CNC not only allows rapid prototyping, but also allows for simpler cooling conditions to be used, making the overall production process faster. This is also the case when a press technique is used.

1.-17. (canceled)

18. A foldable system, the system having a panel consisting of at least two layers, a first flexible layer and a second non-flexible layer, the first and the second layer being attached to each other such that they form a whole, the panel containing folds, the folds being applied in the second layer such that the panel can be folded into a predetermined shape,
the first flexible layer including a material with a melting temperature that is higher than the melting temperature of the second layer.

19. A system according to claim 18, wherein the melting temperature of the first layer at least 80° C. is higher than the melting temperature of the second layer.

20. A system according to claim 18, the first layer comprising at least one of the following materials: PET, polyester, COC (cyclic olefin copolymer), polyamide, polystyrene, polycarbonate, PVC or a mixture thereof.

21. A system according to claim 18, the second layer comprising at least polypropylene.

22. A system according to claim 18, the first and the second layer being adhered to each other prior to the application of the folds.

23. A system according to claim 18, the fold being a groove in the second layer.

24. A system according to claim 18, the desired form being a shape of a boat.

25. A system according to claim 18, the cross-section of a fold being an angle.

26. A system according to claim 25, wherein two fold lines are located next to each other and wherein the distance between the two fold lines is smaller than the width of a fold line.

27. A system according to claim 18, the second layer including material which has a cell structure.

28. A system according to claim 18, wherein at least one fold is applied in the panel such that the panel can be folded up into a more compact form than the desired form.

29. A system according to claim 28, the folds being arranged such that hollow spaces are provided in the more compact form.

30. A system according to claim 28, wherein the folds are arranged so that the more compact form is folded according to a double spiral.

31. A method for applying folds in a panel, the panel consisting of a first layer and a second layer, the first layer having a higher melting temperature than the second layer, and the folds only being applied in the second layer by means of scoring, locally melting away of material or locally pushing away of material,
wherein the second layer is indirectly melted locally by locally heating, at the location where the fold is to be applied, the first layer, below the melting temperature of the first layer, but above the melting temperature of the second layer, and by conduction of the applied heat to the second layer.

32. A method according to claim 31, the folds being applied with a CNC-controlled machine.

33. A method according to claim 32, the local heating being done by means of a thermal source mounted on the CNC-controlled machine.

34. A method according to claim 31, the local heating taking place at a temperature that is between 15% and 50% of the temperature difference between the melting temperature of the first layer and the second layer lower than the melting temperature of the first layer.

35. A method according to claim 31, wherein the locating heating taking place at a temperature that is between 20% and 40% of the temperature difference between the melting temperature of the first layer and the second layer lower than the melting temperature of the first layer.
